(19) United States
(12) Patent Application Publication
(10) Pub. No.: US 2012/0159329 A1
(43) Pub. Date: Jun. 21, 2012

(54) SYSTEM FOR CREATING ANCHORS FOR MEDIA CONTENT

(75) Inventors: Jyh-Herng Chow, San Jose, CA (US); Jerry Ye, Oakland, CA (US); Choon Hui Teo, Sunnyvale, CA (US)

(73) Assignee: Yahoo! Inc., Sunnyvale, CA (US)

(21) Appl. No.: 12/970,519

(22) Filed: Dec. 16, 2010

(51) Int. Cl. G06F 3/01

(52) U.S. Cl. 715/716

(57) ABSTRACT

Disclosed is a method and system for providing intuitive and efficient representations of positions of interest to a user within encoded media. Various embodiments of the present disclosure provide a heatmap representation that indicates the interestingness of content at different locations within the media. These locations of interest are presented to a user to allow quick jumps to the interesting parts of the content.

### FIELD

The present disclosure relates to a system for creating automatic anchors for an item of media content, and more specifically, for rapid identification and access to peak points of interest within the media item.

### RELATED ART

The Internet and other networks are commonly used to delivery media objects (video files, streaming media data, music/audio files, text, images files etc.) to end-user consumers. Many different types of information electronically encoded and distributed by computer systems are rendered for presentation to end users by a variety of different application programs, including text and image editors, video players, audio players and web browsers. With the ubiquity of such computer systems and application programs, people can now consume any content, anytime, and anywhere they like.

Such content comprises information units that are rendered unit by unit for display or presentation to a user. In one example, rendering applications and devices generally allow a user to start or resume the rendering of a video file, to stop rendering of the video file, and to skip forward or backward to select positions within a video stream.

### SUMMARY

The present disclosure describes systems and methods for intuitive and efficient representations of positions of interest to a user within encoded media. Various embodiments of the present disclosure utilize an attention map implementation that indicates the “interestingness” of portions of media content occurring at different locations within the media item. These locations of interest are presented to a user to allow quick jumps to the interesting parts of the content. This is particularly useful when a user cannot afford to spend time to consume the full length of the content, or the user needs to repeatedly consume a specific portion of the content (e.g., learning a dance step).

In an embodiment of the present disclosure, a method is disclosed for generating and inserting anchors within a media item. The method collects user activity related a media item. Based on the collected user activity, a quantitative measurements for the media item are calculated. The method analyzes the measurements to determine a location within the media item. The location, based upon the quantitative measurements, is identified as a high user interest point within the media item. The high user interest point corresponds to (correlated with) a segment, portion or position within the media item having the highest popularity among a user (or users). The method generates an anchor based upon the location within the media item. The generated anchor is annotated with the media item at the identified location. The anchor facilitates an indication that the location corresponds to the high user interest point or segment within the media item. The method then communicates the annotated media item to a user or users for rendering. The anchor enables the user(s) to begin rendering the media item from the anchor.

In accordance with some embodiments, the method further analyzes metadata of the media item to determine attributes of the media item. The media item attributes correspond to the images, audio and/or video (content) of the media item. In some embodiments, the generation of the anchor is further based upon the metadata of the media item. In some embodiments, anchors, and anchor positions can be updated based on real-time analysis of the user activity, where the user activity is collected while a user is rendering the media item.

In another embodiment, a computer-readable storage medium is disclosed for generating and inserting anchors within a media item.

In yet another embodiment, a system is disclosed for generating and inserting anchors within a media item. The system comprises a media module, a user behavior analyzer, anchor generator and content analyzer, all of which are implemented by at least one of a plurality of processors. The media module is configured to retrieve and render a media item. The user behavior analyzer is configured to collect user activity related a media item being rendered. The user behavior analyzer computes quantitative measurements (e.g., a heatmap) of the media item, where the measurements are based upon the user activity related to the rendered media item. The quantitative measurements are related to, or based upon, the user activity related to the media file rendering. The user behavior analyzer is further configured to analyze the measurements to determine a location within the media item, where the location is a high interest point within the media item and is determined based upon the user activity. The anchor generator is configured to generate an anchor based upon the identified location of high interest. The anchor generator is further configured to annotate the media item with the anchor at the location, where the anchor facilitates an indication that the location corresponds to a popular media segment within the media item and enables rendering from the anchor position.

In some embodiments, the content analyzer is configured for analyzing metadata of the media object to determine attributes of the media object, where the attributes of the media object correspond to the content (images, audio and/or video) of the media object. As such, in some embodiments, the anchor generator is further configured to generate the anchor based upon the quantitative measurements computed by the user behavior analyzer and the metadata of the media object analyzed by the content analyzer.

These and other aspects and embodiments will be apparent to those of ordinary skill in the art by reference to the following detailed description and the accompanying drawings.

### BRIEF DESCRIPTION OF THE DRAWINGS

In the drawing figures, which are not to scale, and where like reference numerals indicate like elements throughout the several views:

FIG. 1A illustrates a heatmap in accordance with some embodiments of the present disclosure;

FIG. 1B illustrates an example of information encoding in accordance with some embodiments of the present disclosure;

FIG. 1C illustrates rendering of a video clip in accordance with some embodiments of the present disclosure;

FIG. 1D illustrates an example, shown graphically, of user behavior during rendering of media in accordance with some embodiments of the present disclosure;

FIG. 1E illustrates an example depicting a GUI where the anchors for a video clip are displayed near the bottom of the video;

FIG. 2 illustrates an architecture for creating and inserting automatic anchors within media content in accordance with some embodiments of the present disclosure;

FIG. 3A depicts a block diagram for creating automatic anchors for media content in accordance with some embodiments of the present disclosure

FIG. 3B illustrates a flowchart for creating automatic anchors for media content in accordance with some embodiments of the present disclosure;

FIG. 4 depicts a schematic of a system for automatic anchor creation in accordance with some embodiments of the present disclosure;

FIG. 5 is a block diagram illustrating an internal architecture of a computing device in accordance with an embodiment of the present disclosure.

### DESCRIPTION OF EMBODIMENTS

Embodiments are now discussed in more detail referring to the drawings that accompany the present application. In the accompanying drawings, like and/or corresponding elements are referred to by like reference numbers.

Various embodiments are disclosed herein; however, it is to be understood that the disclosed embodiments are merely illustrative of the disclosure that can be embodied in various forms. In addition, each of the examples given in connection with the various embodiments is intended to be illustrative, and not restrictive. Further, the figures are not necessarily to scale, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

The present disclosure is described below with reference to block diagrams and operational illustrations of methods and devices to insert anchors into media content based on attention mapping of the content. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

The principles described herein may be embodied in many different forms. The present disclosure is directed to the identification of positions of interest within media content. The positions will be denoted as anchors, discussed below. Typically, media content being streamed or transmitted to a user comprises information encoded as information units that are rendered for display or presentation to the user. The media content can be of any form: video, text, audio, images, etc. For example, an MPEG-encoded video file employs a number of layers of different types of encoded frames. The video frames are reconstructed from an MPEG-encoded video file frame-by-frame. Rendering of an MPEPG-encoded video file provides a stream of frames being received and processed by a rendering device. Within each type of content, there are generally particular points or segments that a viewer considers of interest or pays a high amount of attention to. For sake and ease of explanation, the type of media content used to describe the current system will be that of video content. However, this should not be considered a disclaimer of or be understood to exclude embodiments of those implementing other forms of media content.

The described systems and methods disclose identifying interesting segments or locations within a piece of media via attention mapping analysis of the media. The systems and methods may be used with media content of any type including audio streams, video streams, downloaded media, tethered download, interactive applications or any other media content item. The computing device may be any computing device that may be coupled to a network, including, for example, personal digital assistants, Web-enabled cellular telephones, TVs, devices that dial into the network, mobile computers, personal computers, Internet appliances, wireless communication devices and the like. The disclosed system learns from user behavior and feedback, and places anchors, either from an individual user, or from a universe of users. For example, the system can automatically place anchor points at a location in the media item that a user has repeatedly rewound to (or in its proximity) to replay the content. In another example, if there are many users that repeatedly play the same segment, anchor points can be automatically placed at that location. The insertion of anchors will be discussed in greater detail below.

Segment popularity of, by way of a non-limiting example, particular locations or areas within an online video, can be quantitatively measured by how often and how long users watch or replay a particular segment or portion. By way of a non-limiting example, one way of determining the popularity of different parts of a video is to collect user data representing interactions by users with an item of media, such as a video. The collected user interaction data can be analyzed to determine what portions, points or segments of a media item users are viewing the most. In other words, what segments receive the most user attention. The disclosed system learns from user behavior and feedback related to a media item, and identifies the locations within the media item where users, for example, have repeatedly rewound to (or in its proximity) to replay content. The collected and stored data can then be used to make quantitative measurements. In other words, the data can be analyzed using known techniques to provide and apply a mathematical visual representation of the segments.

In accordance with the embodiments of the present disclosure, the system may use a specific attention model to define a context for processing media content, where the context can create a taxonomy and/or weighting condition for attention types. For example, in certain contexts, on type of attention may be valued over another, e.g., a user constantly rewinding a video clip vs. the user fast forwarding the video clip. By modeling the types and forms of attention, the resistance and affordance of attention given a segment of media content can create a unique graph of n-dimensional topology. This topology can be used as a unique identifier for a segment of media or as an attention vector for the media content. As such, any type of data analysis methodology that would yield popularity of segments of media content can be utilized by the various embodiments described herein, for example, a “heat map”.

Heat maps can be used to depict how much attention a specific portion or segment of a media area gets from consumers. These maps provide visual insight into consumer behavior. The heat maps provide an indication as to what content the viewing consumers care about the most, what they read/watch, and what they completely skip over. In other words, the maps assist in deciphering what most users on average are clicking on or gravitating to. The heat map can be constructed using data from aggregated user logs computed by a server, client computing device or backend server, for example.

Heatmaps can also be computed for non-video content. For example, electronic books, magazines, songs, video games, traditional TV programming, etc. For a news article or a web page, how often a user has scrolled to a particular part of the page can be tracked. In these instances, eyeball tracking can be utilized. The most viewed and reviewed part of an article or web page will be the “hottest part” in the heatmap.

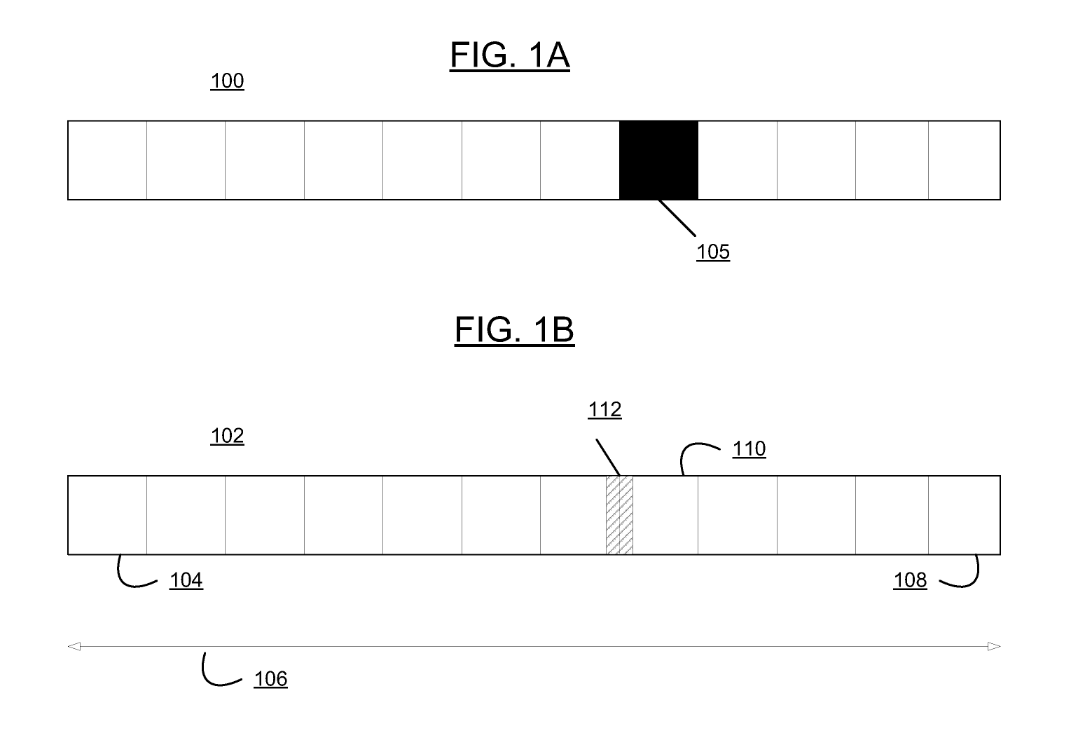

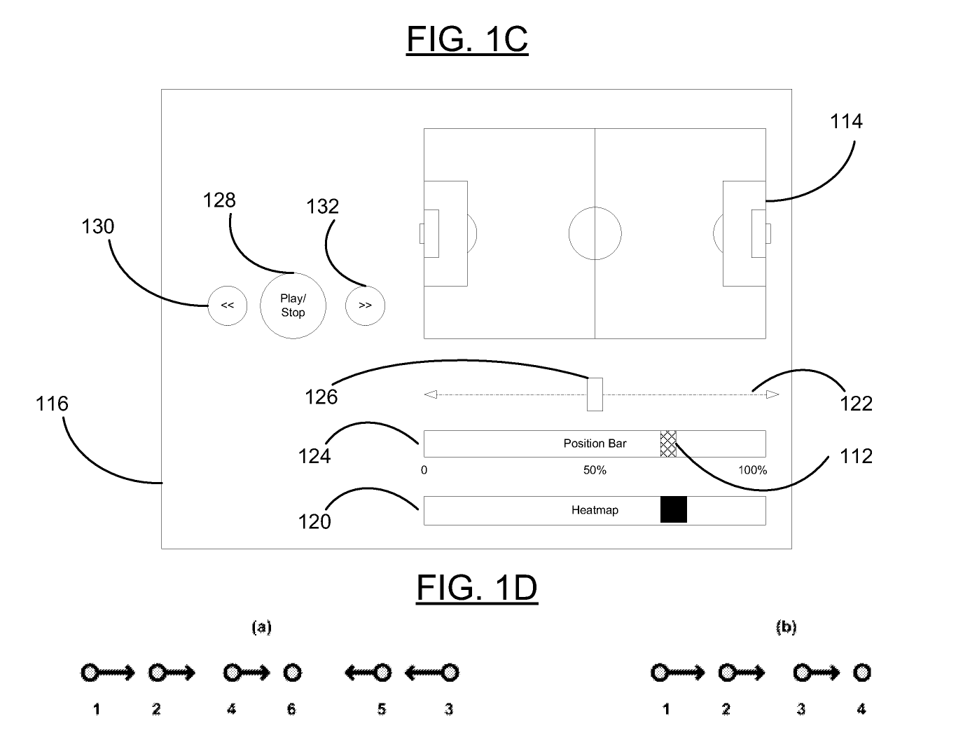

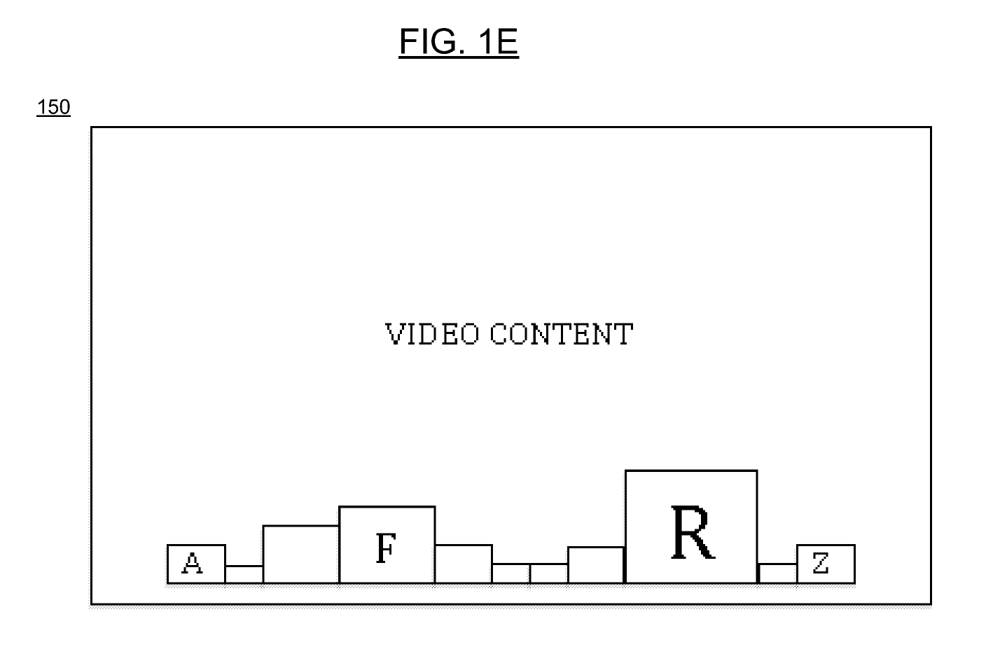

As discussed above, the described systems and methods disclose placing an anchor where there is the most user attention in order to determine and identify or isolate the most popular parts of content. This enables an insertion or annotation of an anchor into a media item at or around, or at the beginning or immediately prior to the popular or most popular parts. FIG. 1A shows heatmap 100 for an item of media content. As illustrated, the content begins at the left, and ends at the right. The interestingness of the content is not evenly distributed over the length of the content. Most commonly, the more popular parts of a heatmap are indicated by a redder shade while unpopular parts are a darker shade. Embodiments can also exist where differing levels of a gray-scale or color scheme can denote the level of interest. This can be referenced by a legend, or supplemental documentation. As such, heatmaps may use differences in shading, colors, or other visual cues in order to represent the magnitudes of relatedness metrics computed for positions within media content. For illustrative purposes with reference to FIG. 1A, the popular regions of the heatmap will be shaded dark, while the low interest regions will not be shaded. This is solely for illustrative purposes to highlight the locations of interest within a media file, and should not be viewed as a limiting nature of the disclosed heatmaps.

In particular, various embodiments of the present disclosure provide a heatmap representation of relatedness at each location or position of high interest within media content. The heatmap visual representation allows a user to identify positions of particular interest, and to directly access the information at those positions via anchors. This allows the user to avoid time-consuming and inefficient hit-or-miss searching techniques.

As depicted in FIG. 1A, segment 105 represents the segment or portion with the highest point of user interest within a media file. The types of user behavior that can contribute to feedback for formulation of a heatmap include, but are not limited to, a user rewinding to a previously viewed location, a user enlarging the screen at a certain point during rendering, a user abandoning the video during rendering, a user fast forwarding through a segment (as illustrated in FIG. 1D), and the like.

FIG. 1B depicts an encoding of the media content from FIG. 1A, where the progress of the rendered media content begins at the left and ends at the right. Such depiction shows a sequentially ordered information encoding of the media content. The encoding can comprise an ordered sequence 102 of information units, including, for example, information unit 104, which is first unit within the sequence. As in FIG. 1B, the information unit depicted on the left, unit 104, represents the initial information unit that is to be rendered, while the information unit depicted on the right, unit 108, represents the final information unit that can rendered within the media file.

The location of any particular information unit in the ordered sequence of information units can be described by a position within the ordered sequence of information units. Most types of electronically encoded information can be considered to be ordered sequences of information units. For example, files stored within a computer system can be broken down to arrays of bytes, with the position of each byte indicated by an index or byte offset from the beginning of the file. In FIG. 1B, positions within the media content are represented by a horizontal position axis 106 parallel to the ordered sequence of information units. A position can be expressed as an index, in temporal units, or in other ways known in the art.

In FIG. 1B, unit 110 directly corresponds to location 105 on the heatmap 100 in FIG. 1A. Thus, because unit 110 and segment 105 correlate to one-another, an anchor 112 can be placed in the progress bar of a video rendering (or in some embodiments, additionally or alternatively in a displayed heatmap). An anchor is a fixed point in media content that is identified by a high interest point on a heatmap. The determination as to the placement of anchors will be discussed in greater detail with reference to FIG. 1C, but for general purposes, anchor 112 would be placed at or around unit 110 of the media content to indicate to a user that the location was a point of high interest.

FIG. 1C illustrates rendering of a video clip by a media player incorporated in, or accessed by, a web browser or application program that displays a web-page graphical user interface (GUI) on a display of a computing device. Video is displayed within a video screen 114 provided by the GUI 116. A progress display 122 displays, to a user, an indication of the current position within a video clip being displayed during rendering. The entire length of the video clip is represented by horizontal/position bar 124 and the current position being indicated by position indicator 126. The position indicator 126 indicates that the currently displayed video frame occurs at a position 50% of the way through the clip. The user interface provides a start/stop button 128 for starting and stopping video clip display, as well as a backward-advance button 130, and forward advance button 132 that allows the user to seek different positions within the video clip without watching intervening frames.

As discussed in FIGS. 1A-1B, anchor 112 can be automatically placed within the bar 124. Anchors can be placed at or around, or immediately prior to the area or location where the heatmap indicates high points of interest. In some embodiments, heatmap 120 corresponding to the media content can be visibly displayed on the GUI. The heatmap 120 displays that a high popularity segment appears around three-fourths of the way through the media content. As such, there exist embodiments where the anchor 112 can be placed within the heatmap 120, progress display 122, and/or the bar 124. As illustrated, the anchor 112, displayed on the bar 124, corresponds to location and indication of the high popularity segment as shown in the depicted heatmap 120. Anchors can be placed at the beginning, or immediately prior to an identified segment, so that when a user jumps to that position, the entire portion of the segment can be rendered.

Anchors can be tags, markers or identifiers that indicate to a viewing user that the position where the anchor is situated is a popular segment. In some embodiments, the anchors can be more than an identifier. An anchor can trigger a screenshot of the scene within the media. An anchor can also provide a sample of the content segment, either in the same window or in a subsequent viewing window. The screenshot can appear when a user either holds the mouse pointer over the anchor, or the user clicks on or around the anchor via a mouse click (or some other user input). In some embodiments, the size of the screenshot can be varied based upon how interesting the location is at the anchor. For example, if there are two anchors placed within a video stream, and the first anchor is located at the most popular segment of the video, and the second anchor at the second most popular segment, the first anchor can effectuate a larger sized screenshot than that of the second anchor. In other embodiments, anchors can trigger visual effects which affect the viewing of the media. For example, an anchor can enable the video to become full screen in size, or enlarge or resize the video.

In some embodiments, anchors can also be placed in areas where the heatmap for media indicates significant changes of user interest: from low to high, or high to low. In some embodiments, if a user adjusts position indicator 126 (or slider) back-and-forth until a point where the user or other users continuously consume the content, then that point can be recorded as a location where an anchor can be placed. Accordingly, the anchor should only be placed after the point of content has been played continuously for a good period of time. This is contingent upon a threshold that guarantees that the content is indeed popular. The threshold can be set by a user, a plurality of users, the system or the publishers of the content. This enables each respective party the ability to set a preference that enables a desired attention analysis of the item of media content. In some embodiments, an anchor can also be placed within media content if a specific location within media has been directly accessed (e.g., on YouTube©) via a URL. Additionally, in some embodiments, the system can also employ an explore-and-exploit strategy. In such strategy, the system explores the proximity of anchor candidates by presenting alternatives to the user, and then collects user feedback to gain confidence. Accordingly, a confidence level can be set, so that after a number of times a media file has been rendered, the quantitative data that has been collected can be presumed accurate.

As an example, FIG. 1D depicts slider (or position indicator 126) movements when a user views a video. This is demonstrative of the type of user behavior that is collected in determining high attention segments of media where an anchor (or anchor range) will be placed. Each circle indicates the slider placement on a progress bar. The numbers indicate the sequence of movements, and the arrows indicate the direction. In case (a), the user moves the slider back-and-forth incrementally according to the number position points until point 6, where the user was finally satisfied. In other words, as illustrated, the user moves the slider from position points 1, to 2, 3, 4, 5 and finally point 6. In case (b), the user moves the slider in one direction and was satisfied at point 4. The system can infer that point 6 in case (a) and point 4 in case (b) are effective anchors. In addition, from case (a), the system can infer that somewhere between point 4 and point 5 could also be a good anchor (or anchor range), although with a less degree of confidence. The system can become more confident of its potential anchor candidates as more user feedback is collected. In accordance with some embodiments, the system may also analyze the content to identify suitable anchor points. For example, changes in scene, color histogram, sound or tone. The system may also obtain input from external sources. For example, a specific location being commented on by many users, as in the case of e-books or online video content.

By way of another non-limiting example, FIG. 1E illustrates a GUI 150 (similar to the GUI depicted in FIG. 1C) where the anchors for a video clip being displayed within the GUI are shown near the bottom of the video. As depicted and discussed above, the boxes are frames from the top segments in the video. The size of the boxes shows how popular a particular segment is, where larger boxes are more popular. In the Figure, frame A corresponds to a first anchor of the video clip, Z is the last anchor, R is the most popular segment of the video, and F is the second most popular. The other frames, although not labeled, do not limit the embodiments that can arise where they represent anchor positions and/or popular segments of the video. Accordingly, frames may or may not be at a set time interval. According to some embodiments, the time interval for a frame may only correspond to the most popular segment(s).

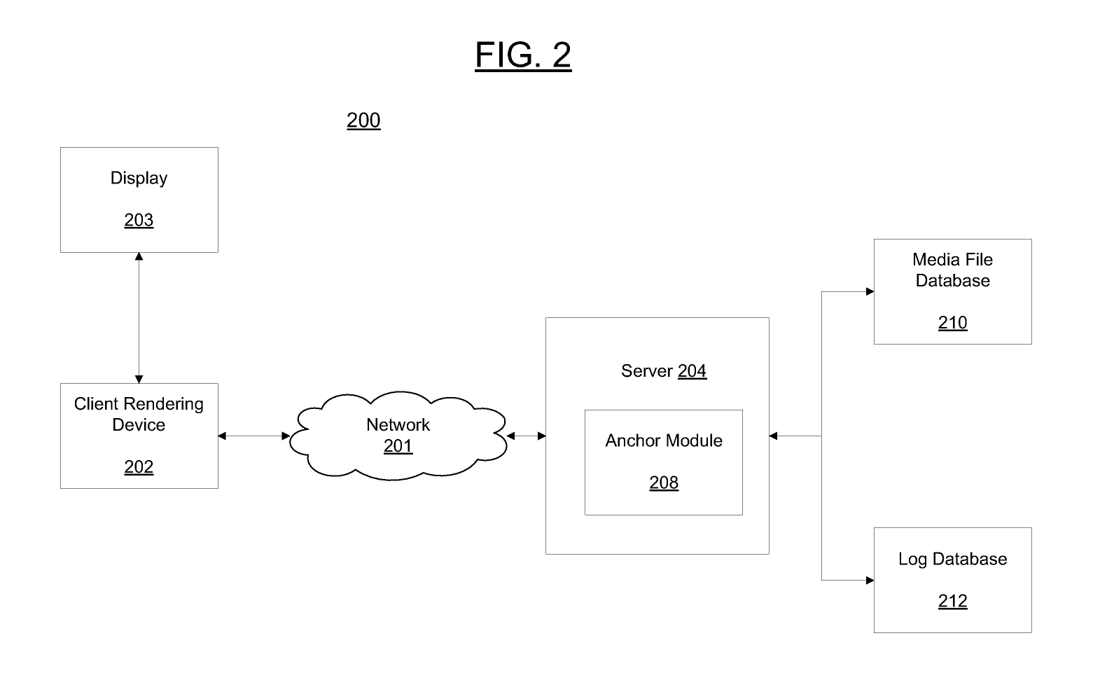

Embodiments of the present disclosure are directed towards identifying locations, or positions of desired content within a media item via anchors, and accessing the desired content at the identified positions. FIG. 2 illustrates an embodiment of an architecture for creating and inserting automatic anchors within media content. The architecture 200 is a computing architecture in which media is rendered by a computing (or rendering) device 202. The architecture 200 illustrated is a networked client/server architecture in which a rendering device 202 (referred to as a “client”) issues media requests to a remote computing device 204 (referred to as a “server”), which responds by transmitting the requested media content to the client 202 for rendering to a user. The systems and methods described herein are suitable for use with other architectures as will be discussed in greater detail below.

For purposes of this disclosure, a computing device such as the client 202 or server 204 includes a processor and memory for storing and executing data and software. Computing devices may be provided with operating systems that allow the execution of software applications in order to manipulate data. In the embodiment shown, the client 202 can be a computing device, such as a personal computer (PC), web enabled personal data assistant (PDA), a smart phone, a media player device, or smart TV set top box. The client 202 is connected to the network, such as the Internet, 201, via a wired data connection or wireless connection such as a wi-fi network, a satellite network or a cellular telephone network.

The client 202 includes an application for receiving and rendering media content. Such applications are commonly referred to as media player applications. The media player application, which runs on the client rendering device 202, includes a graphical user interface (GUI), which is displayed as attached to or part of the computing device 202 on a display 203. The GUI, as similarly discussed in FIG. 1C, includes a set of user-selectable controls through which the user of the client device 202 can interact to control the rendering other media content. For example, the GUI on the client computing device 202 may include button control for each of the play-pause-rewind-fast forward commands commonly associated with the rendering of media on rendering devices. By selecting these controls, the user can generate rendering data (or user activity data) from which an attention map of the content can be generated, as discussed below.

The architecture 200 also includes server 204, which may be a single server or a group of servers acting together, either at one location or multiple locations. A number of program modules and data files may be stored in a mass storage device and RAM on the server 204, including an operating system suitable for controlling the operation of a networked server computer. Accordingly, the server 204 and client 202 can be embodied as a single computing device, or multiple devices, at one location or multiple locations.

In the architecture 200 shown, a client 202 is connected to a server 204 via a network 201, such as the Internet as shown. The client 202 is configured to issue requests to the server computer 204 for media content. In response, the server computer 204 retrieves or otherwise accesses the requested media content and transmits the content back to the requesting client 202. The requested media content may be stored as a discrete media object (e.g., a media file containing renderable media data that conforms to some known data format) that is accessible to the server 204. In the embodiment shown, a media file database 210 is provided that stores various media content objects that can be requested by the client 202. The media file database 210 can be implemented on one or more content sources existing on a network, or can be associated with the server 204.

The client 202, upon receipt of the requested media content, may store or download the media content for later rendering. Alternatively, the client 202 may render the media content as quickly as practicable while the content is being received in order to reduce the delay between the client request for content and the initiation of the rendering of the content to the user—a practice referred to as rendering “streaming media.” When rendering streaming media, the client 202 may or may not store a local copy of the received media content depending on the system.

The server 204 includes an anchor module 208. The anchor module 208 is configured to request the media content from the media file database 210. The anchor module 208 can transmit content, and appropriately and timely insert anchors into the content based on attention mapping information for the content stored in the log database 212.

The log database 212 houses behavioral and feedback information collected and stored from a universe of media content consumers or users. Such information is collected and stored by the anchor module 208. The anchor module 208 computes the heatmap for media content and assists in generating anchor candidates. This information is collected and stored in the log database 212. The user feedback can be collected, stored and applied in real-time as users interact with the media (play, fast forward, rewind, etc.), or the feedback can be collected for offline use. In the instances the feedback is collected for offline use, the logs can be updated at some predetermined interval (e.g., once per night, or at a predetermined time interval set by publishers of the content, by the system, or by the users).

The attention mapping for each piece of media content, and their respective segments, are computed by the anchor module 208, and stored as logs in the log database 212. The logs comprise quantitative measurements deduced from rendering operations as users interact with the client rendering device 202 and the accompanying GUI. As discussed above, the GUI on the client computing device 202 can include button controls to play-pause-rewind-fast forward media content. The anchor module 216 monitors these controls as a plurality of user interact with media, and generates rendering (or user activity) data from which a heatmap for content can be visualized as sufficient user data is collected from the universe of users. The heatmap can be stored as a log in the log database 212. The logs in the log database 212 can identify anchor identifiers for different portions of media content. The anchor identifiers pinpoint locations where the associated heatmap identifies segments of content being proportionally popular to the other segments of content within a media file. The anchor module 208 can actively interact with the log database 212, client 202 and the media file database 210 in order to monitor and analyze the rendering of the media content and users' behavior during rendering. This enables real-time updating of anchor positions based upon a user's, or users' rendering activity.

In some embodiments, user-specific heatmaps can be generated for a particular user's viewing behavior by the anchor module 208. This information (i.e., the user specific heatmaps) would be stored as user specific logs within the log database 212. As such, the user-specific logs can generate user-specific anchors for particular users. The individual heatmaps can be constructed using existing machine learning techniques. In some embodiments, user specific logs may be formulated according to user demographic information including user age, location, income or interests. In an embodiment, user demographic information may be stored within the log database 212 and identified according to the particular user and/or which demographic the user or media file falls within. In some alternative embodiments, user logs can be stored on the server 204. In an alternative embodiment, user logs and demographic information may be stored within a client-side cookie on the client rendering device 202. In this instance, appended to the request for media content would be identifying information that the server 204 and log database 212 utilize to identify the user specific logs. In some alternative embodiments, the user may login via a login ID provided at a GUI on the display 203. This enables the user to be properly directed to his/her personal user logs stored in the log database 212.

The log database 212 is a data source from which the information collected is representative of quantitative measurements of how often and how long users watch or replay particular segments of the media content. Heatmap information for the each piece of media stored in a media file database 210 can be stored in the log database 212. According to some exemplary embodiments, popularity of different segments of media content is determined via the heatmap, clustering algorithm or data analysis technique computed by the anchor module 208. As discussed above, heatmaps show how much attention a specific segment of media receives from consumers who have rendered the media. The heatmaps provide insight into consumer behavior. The maps provide indicators as to which portions of media content the viewing consumers care about the most, what they read/watch, and what they completely skip over. For example, media segments that have been similarly tagged by a large number of users can be assumed to be segments that users are paying a lot of attention to.

Based on the information stored in the log database 212, server 204 can identify specific portions of the requested media that correspond to peak interest segments of the media. In this case, the server 204 receives not only the media content, but also the indicators that trigger anchor insertion at the opportune times.

By way of a non-limiting example, a user may request a video that is streamed to rendering device. As the video is being streamed (e.g., played on by the media player), the different portions of the video are transmitted to the user. If, for example, one portion of the video has been identified as the climax of the video, where the majority of users have either replayed or paused the video during that portion, an anchor can be placed at the beginning, immediately prior, or in a proximity to this portion or position.

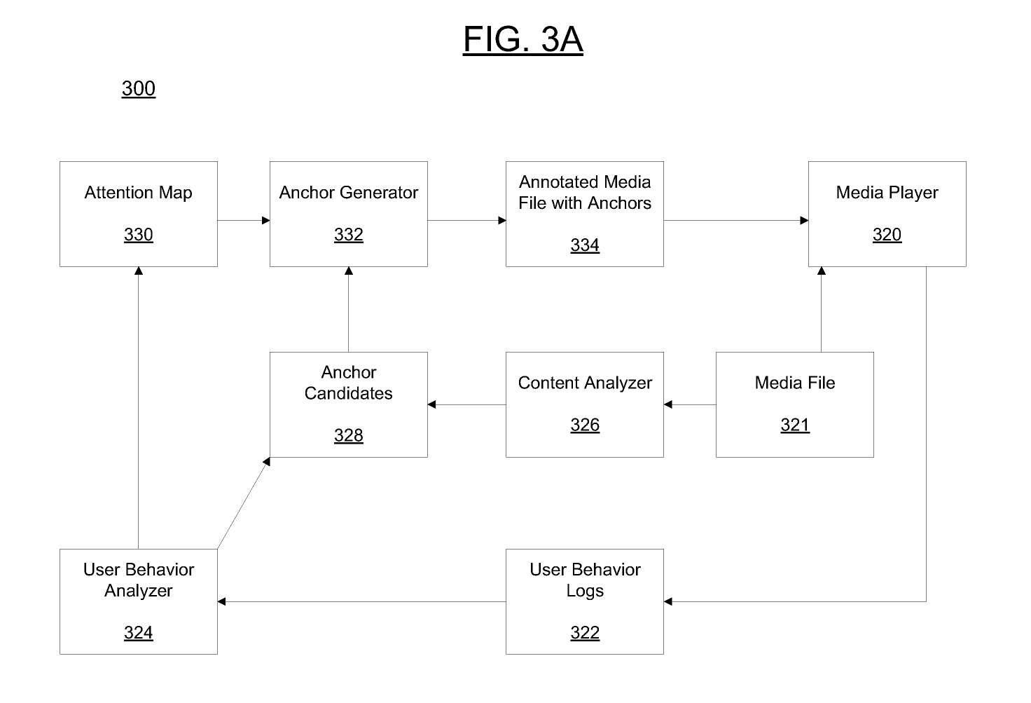

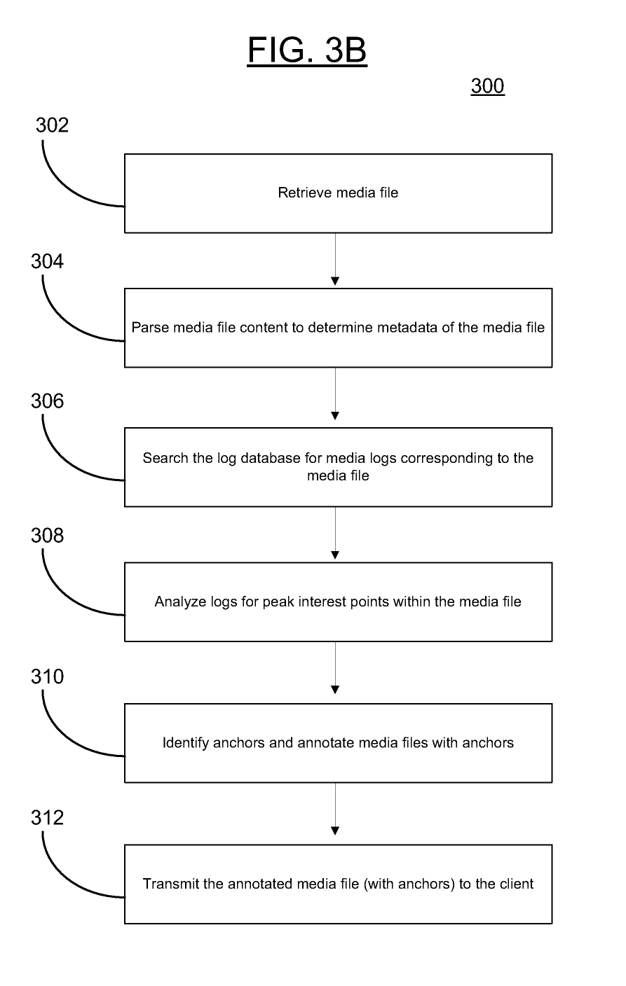

FIGS. 3A and 3B illustrate a method for creating automatic anchors in accordance with an embodiment of the present disclosure. FIGS. 3A and 3B provide an illustrative view of the method 300 for identifying interesting segments of media and determining anchors for the media. FIG. 3A is a block diagram of the system for creating automatic anchors, and FIG. 3B illustrates a workflow of an order of operations for creating automatic anchors. In some embodiments, when a piece of media content is to be played, the system can show, along with the associated anchors, the heatmap of the content, which may or may not also have an anchor annotated therewith. This is illustrated in FIG. 1C.

In FIG. 3A, the method 300 begins by a user consuming content through a media player 320. The media player 320 has a set of controls such as play, stop, pause, resume, rewind, fast forward and backward. In exemplary embodiments, the user will be able to choose to play from an anchor or jump from one anchor to another quickly. While the user operates the media player 320 to render the content 321, all user activities (such as play, rewind, anchoring—rendering from an anchor position) are collected. The user activities are collected and denoted as User Behavior Logs 322. These logs are stored in a log database, as discussed above in FIG. 2. According to some embodiments, these User Behavior Logs 322 are collected over a period of time from a same user, or across all users, and are analyzed by the User Behavior Analyzer 324. The User Behavior Analyzer 324 computes the attention map/quantitative measurements (or heatmap) 330 of the content and assists in generating anchor candidates 328.

In some embodiments, the media content 321 can be analyzed by the Content Analyzer 326. In one aspect, the Content Analyzer 326 determines places of various changes in the content 321, such as scenes, colors, or voices, as identified by analyzing the metadata of the content. The Content Analyzer 326 can also collect user feedback respective of the media content in real-time as users interact with the media (play, fast forward, rewind, etc.), or the feedback can be collected for offline use. In the instances the feedback is collected for offline use, the logs can be updated at some predetermined interval (e.g., once per night, or at a predetermined time interval set by publishes of the content, by the system, or by the users of the systems). The information collected by the Content Analyzer 326 can be utilized for generating anchor candidates 328 automatically (or applied in real-time).

The Anchor Generator 332 uses the output from the Content Analyzer 326 and User Behavior Analyzer 324 to generate the final anchor points and automatically annotate the media file with the anchors 334. In some embodiments, the Anchor Generator 332 can update existing anchors. This occurs when anchors already existed within the content, and the collected user feedback has altered the position of the anchors. Updating, along with annotation, can occur automatically, in real-time, and/or in accordance with a preset time interval. These can be personalized or non-personalized, and are presented to the user in the media player 320. In some embodiments, the anchor points can be automatically annotated to a heatmap. In the case of candidates whose surrounding heatmap shows high interest but with low confidence scores, the Anchor Generator 332 can deploy the explore-and-exploit strategy to learn more signals from user feedback. As discussed above, the explore-and-exploit strategy explores the proximity of anchor candidates by presenting alternatives to the user, and then collects user feedback to gain confidence. Thus, the Anchor Generator 332 can then update anchor positions.

Providing anchors for media content can provide a great improvement to user experience in media applications. As content is viewed more and more and becomes easily accessible, people will want to be able to quickly get to the most interesting part of the content quickly. This provides distinct advantages from bookmarking and other known techniques in the field. The system dynamically learns from user behavior to generate anchors, which can be also personalized if needed. The system can generate anchors automatically for millions or even billions of pieces of media content as long as there are enough user feedback to learn from. Additionally, there is no limit to the amount of users who can implement the instant system. The system can adapt itself to user interest or external factors, which may change over time. For example, an old high school video of Barack Obama could very likely have a very different heatmap now that he is President. Additionally, as discussed above, the system can be applicable to all types of media and can use personalized collected media to better serve a specific user with personalized anchors.

In FIG. 3B depicts a workflow of an embodiment for creating automatic anchors. The method 300, as illustrated by the block diagram in FIG. 3A, depicts various operations that may be performed by a media server or computing device or may be distributed between several devices. The method 300 begins with a media server retrieving a requested media file from a computing device (e.g., a computing device running a media player). Step 302. This may include accessing a media file database, or retrieving the media file from a cache, local memory or local data source. In Step 304, the media server parses the media file content to determine identifying information relating to the media file. In some embodiments, this is performed by the Content Analyzer 326 from FIG. 3A. Such information can be metadata associated with portions of the media file. The metadata may also include keywords or markers for different portions of the media file. Additionally, the metadata may include demographic data identifying one or more demographic groups for which the media file, or more specifically portions of the media file, relate to. Based on this information, the server searches the log database for logs specific to the media file. Step 306. The logs provide quantitative measurements, determined by User Behavior Analyzer 324, of how and how often users view particular segments of the media content. According to some exemplary embodiments discussed herein, popularity of different segments of media content is determined via attention mapping of the content, e.g., a heatmap. The attention maps show how much attention specific segments of the media items have received from a universe of users or consumers who have rendered the media items. This information is stored as the log files for each media file. In other words, the attention maps provide insight into consumer behavior when rendering a media file. In Step 308, the logs are analyzed in order to identify indicators as to which portions of media content the viewing consumers care about the most (e.g., what they read/watch, and what they completely skip over). These portions of the media file are the highest points of interest. Step 308 can be performed by Anchor Generator 332, which uses the output from the Content Analyzer 326 and the User Behavior Analyzer 324. As such, these portions will be denoted by anchors that can be input into the media stream and sent to the user.

In some embodiments, there may exist situations where media files do not have logs present in the log database. These instances arise when there is generally a low viewing history for the file, or if the file is new, or relatively new. In these instances, the system can also employ an explore-and-exploit strategy. In such strategy, the system explores the proximity of anchor candidates by presenting temporary anchors to the user, and then collects user feedback to gain confidence. Accordingly, a confidence level can be set, so that after a number of times a media file has been rendered, the heatmap's quantitative data that has been collected can be presumed accurate. Additionally, in some embodiments, historical data of similar media files can be utilized to determine potential or temporary points of interest, until the instant media file has generated enough data to exhibit reliable rendering habits. As discussed above, in Step 304, the media file is parsed, resulting in identified metadata for the media file. The metadata can provide demographic information, as well as the genre of media. With this information, a new media file, based on the parsed metadata, can be approximated to have similar points of interest to a similar known media file.

By way of a non-limiting example, upon identifying a new media file without a log file, the server can search for other media files within the same genre in an effort to find similar attention areas and/or to determine what type of ad to place, e.g., an ad that is in some way related to the media item content, context, or past user behavior data. For example, the new and unknown video is a music video of a pop song. Generally, the specific points of interest of pop songs can be set at the ⅓ marker and ⅔ marker in the video, as the most popular portion of these types of songs and videos are generally the chorus/refrain of the song—songs usually have 2 refrains and 3 verses. As such, since the new video has unknown quantitative values as per the log database, peak points of interest will initially be assumed to occur during the presumed refrains. These points will be maintained until enough data has been compiled from user rendering, where accurate historical/behavioral data (or points of interest via an attention map) can properly be identified. These determinations will be performed by the User Behavior Analyzer 324 from FIG. 3A. In some alternative embodiments, a specific user's behavior data can provide the adequate directive for determining points of interest respective of anchor placement. For example, if a user, upon viewing a music video, regularly stops the video half way, and replays the first portion of the video, points of interest for the unknown video may be set either at the beginning of the video, and/or immediately prior to the half-way point of the video. Accordingly, a confidence level can be set, so that after a number of times a media file has been rendered, the heatmap's quantitative data that has been collected can be presumed accurate.

After the peak points of interest from the log have been identified, anchor points are identified with respect to the points of interest. As discussed above, the Anchor Generator 332 from FIG. 3A generates anchor points and annotates the media files with the anchors. Step 310. These are presented to the requesting user for rendering on the media player. In Step 312, the anchor points and the media file are transmitted to the client. In some embodiments, the anchor points and the media file may be transmitted together in a combined communication or the anchors and the media file may be streamed independently.

According to some embodiments, the number of anchors inserted into media can be set according to a numerical or time-based threshold. For example, in a one minute media file, a threshold may be set to a total of three anchors. Therefore, upon analyzing the media logs retrieved from the log database, the segments showing the three highest points of interest within the media will have anchors inserted at those locations. Also, the anchors may have to be placed at positions being a certain time apart. The application numerical and time-based thresholds avoid saturating the media content with anchor points so that a user can fully appreciate the truly popular segments of a video. Accordingly, threshold notation can be set by a user via user preferences, and/or publishers of the media content. In some embodiments, a user can manually insert anchors into content. These anchors will then be utilized during the analysis of the user feedback.

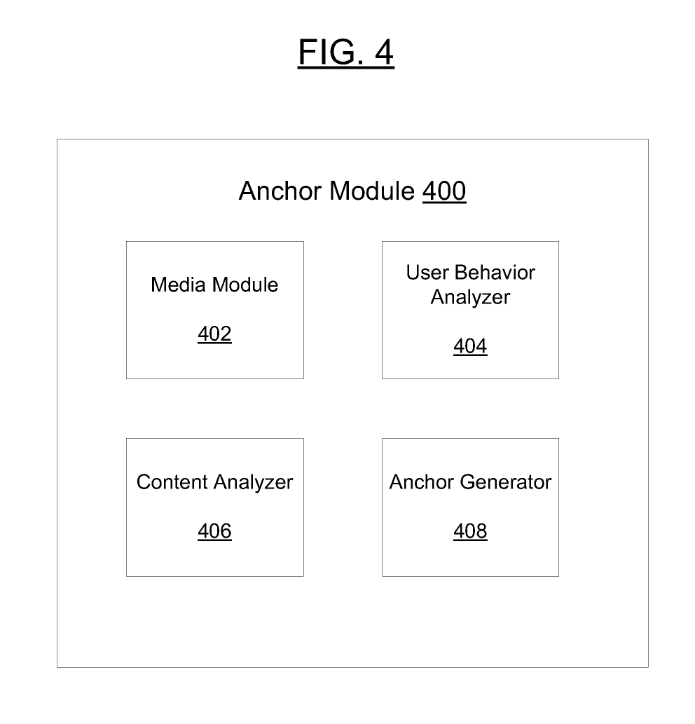

FIG. 4 illustrates an embodiment of the anchor module discussed in FIGS. 2-3B. In some embodiments, the anchor module 400 could be hosted by a user computing device. In another embodiment, the anchor module 400 could be hosted by the web server. In yet another embodiment, the anchor module 400 could be hosted by the content provider or backend server. For example, it is possible that a media player application plays the media content from a local disk drive and collects user behavior logs locally via a local anchor module 400. The anchor module 400 can adjust the anchoring automatically locally, or it may periodically send the collected log(s) to a remote server so that aggregated user behavior can be measured and analyzed.

The anchor module 400 comprises a Media Module 402, User Behavior Analyzer 404, Content Analyzer 406 and an Anchor Generator 408. The Media Module 402 is configured to receive a user request for a content page. As discussed above, the request can be generated by the user searching for a content page via a web browser. The Media Module also performs a search for the requested content. The User Behavior Analyzer 404 computes a heatmap of the content and helps to generate anchor candidates. The Content Analyzer 406 analyzes the retrieved content and determines the intricacies of the content related to, but not limited to, scene changes, colors, audio, and the like. These determinations are utilized by the Anchor Generator 408. The Anchor Generator uses the output from the Content Analyzer 406 and the User Behavior Analyzer 404 to generate anchor points. The generated anchor points are annotated to the media content and served to the user. In some embodiments, the anchor points can be annotated to the media content's heatmap. These embodiments are preferential when the heatmap is being displayed to the user on a GUI that is rendering the media.

As described above, a rendering device (or client) for use with the systems and methods described herein need not be a personal computer. In an embodiment, the user may be viewing song or news article, or listening to a song or podcast on a portable device, such as an mp3 player or a pad/tablet computing device. The rendering device may be a purpose built device for interacting only with the media server or may be a computing device that is provided with the appropriate software.

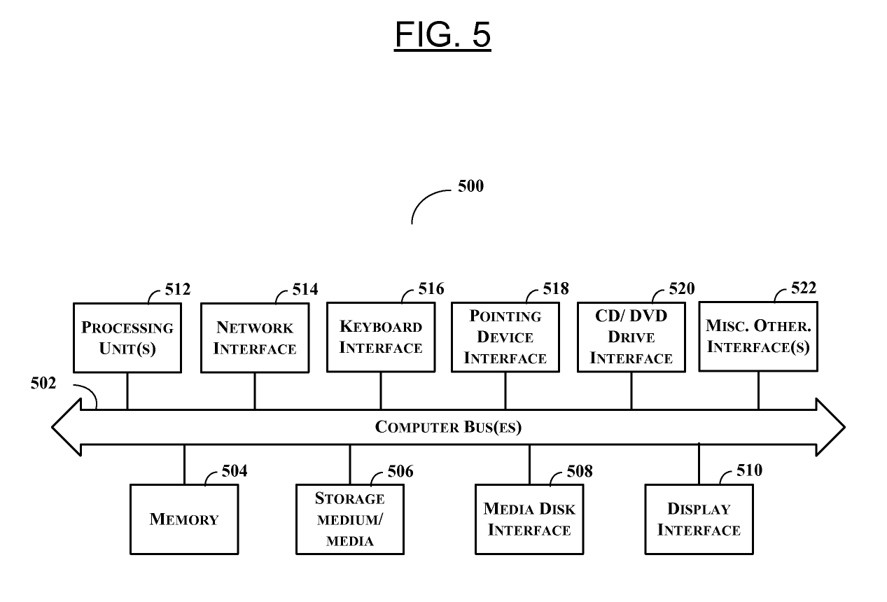

FIG. 5 is a block diagram illustrating an internal architecture of an example of a computing device, such as server computer 204 and/or user computing device 202, in accordance with one or more embodiments of the present disclosure. A computing device as referred to herein refers to any device with a processor capable of executing logic or coded instructions, and could be, as understood in context, a server, personal computer, set top box, smart phone, pad computer or media device, to name a few such devices.

As shown in the example of FIG. 5, internal architecture 500 includes one or more processing units (also referred to herein as CPUs) 512, which interface with at least one computer bus 502. Also interfacing with computer bus 502 are persistent storage medium/media 506, network interface 514, memory 504, e.g., random access memory (RAM), run-time transient memory, read only memory (ROM), etc., media disk drive interface 508 as an interface for a drive that can read and/or write to media including removable media such as floppy, CD-ROM, DVD, etc. media, display interface 510 as interface for a monitor or other display device, keyboard interface 516 as interface for a keyboard, pointing device interface 518 as an interface for a mouse or other pointing device, and miscellaneous other interfaces not shown individually, such as parallel and serial port interfaces, a universal serial bus (USB) interface, and the like.

Memory 504 interfaces with computer bus 502 so as to provide information stored in memory 504 to CPU 512 during execution of software programs such as an operating system, application programs, device drivers, and software modules that comprise program code, and/or computer-executable process steps, incorporating functionality described herein, e.g., one or more of process flows described herein. CPU 512 first loads computer-executable process steps from storage, e.g., memory 504, storage medium/media 506, removable media drive, and/or other storage device. CPU 512 can then execute the stored process steps in order to execute the loaded computer-executable process steps. Stored data, e.g., data stored by a storage device, can be accessed by CPU 512 during the execution of computer-executable process steps.

Persistent storage medium/media 506 is a computer readable storage medium(s) that can be used to store software and data, e.g., an operating system and one or more application programs. Persistent storage medium/media 506 can also be used to store device drivers, such as one or more of a digital camera driver, monitor driver, printer driver, scanner driver, or other device drivers, web pages, content files, playlists and other files. Persistent storage medium/media 506 can further include program modules and data files used to implement one or more embodiments of the present disclosure.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “end user” or “user” should be understood to refer to a consumer of data supplied by a data provider. By way of example, and not limitation, the term “user” can refer to a person who receives data provided by the data provider over the Internet in a browser session, or can refer to an automated software application which receives the data and stores or processes the data.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method, comprising:
collecting, via a computing device, data representing user activity related to a media item;
calculating, via the computing device, quantitative measurements for the media item based upon the user activity;
identifying, via the computing device, a location within the media item that is a high user interest point based on the quantitative measurements, said high user interest point corresponding to a segment of the media item having the highest popularity;
annotating, via the computing device, the media item with an anchor at said location that provides an indication that the identified location corresponds to said high user interest point within the media item and that enables the user to begin rendering the media item from the anchor; and
communicating, via a computing device, said annotated media item to a user for rendering.

2. The method of claim 1, further comprising:
analyzing, via the computing device, metadata of the media item to determine content attributes of the media item.

3. The method of claim 2, wherein said annotating further comprising basing the anchor annotation upon the metadata of the media item.

4. The method of claim 1, wherein said collecting occurs of a predetermined time period.

5. The method of claim 1, wherein, upon the user interacting with the anchor, a screenshot of content of the media item at the location is visibly displayed.

6. The method of claim 1, wherein the user activity data is based upon activity by a universe of users.

7. The method of claim 1, wherein the user activity data is based upon activity by the user, wherein said anchor is a personalized anchor that is specific to said user.

8. The method of claim 1, wherein said quantitative measurements are stored as a log file in a log database, wherein said quantitative measurements are computed for each segment of the media item.

9. The method of claim 1, further comprising:
updating the anchor based upon real-time collection of the user activity, wherein said user activity corresponds to user rendering of the media item.

10. The method of claim 1, wherein said anchor is a plurality of anchors corresponding to a number of high interest points within the media item, wherein the number of high interest points is contingent upon a predetermined threshold.

11. A computer-readable storage medium tangibly encoded with computer executable instructions, that when executed by a computing device, perform a method comprising:
collecting data representing user activity related to a media item;
calculating quantitative measurements for the media item based upon the user activity;
identifying a location within the media item that is a high user interest point based on the quantitative measurements, said high user interest point corresponding to a segment of the media item having the highest popularity;
annotating the media item with an anchor at said location that provides an indication that the identified location corresponds to said high user interest point within the media item and that enables the user to begin rendering the media item from the anchor; and
communicating said annotated media item to a user for rendering.

12. The computer-readable storage medium of claim 11, further comprising:
analyzing, via the computing device, metadata of the media item to determine content attributes of the media item, wherein said annotating further comprises basing the anchor annotation upon the metadata of the media item.

13. The computer-readable storage medium of claim 11, wherein said collecting occurs of a predetermined time period.

14. The computer-readable storage medium of claim 11, wherein said quantitative measurements are stored as a log file in a log database, wherein said quantitative measurements are computed for each segment of the media item.

15. The computer-readable storage medium of claim 11, further comprising:
updating the anchor based upon real-time collection of the user activity, wherein said user activity corresponds to user rendering of the media item.

16. The computer-readable storage medium of claim 11, wherein said anchor is a plurality of anchors corresponding to a number of high interest points within the media item, wherein the number of high interest points is contingent upon a predetermined threshold

17. A system of an anchor module, comprising:
a plurality of processors;
a media module, implemented by at least one of the plurality of processors, configured to retrieve and render a media item;
a user behavior analyzer, implemented by at least one of the plurality of processors, configured to collect user activity related a media item being rendered, wherein the user behavior analyzer computes quantitative measurements for each segment of the media item, said measurements are based upon the user activity related to the rendered media item;
the user behavior analyzer further configured to analyze the quantitative measurements to determine a location within the media item, said location being a high interest point of the media item;
an anchor generator, implemented by at least one of the plurality of processors, configured to generate an anchor based upon said location that provides an indication that the location corresponds to the highest popularity segment within the media item; and
the anchor generator further configured to annotate the media item with the anchor at said location, said anchor enables a user to begin rendering the media item from the anchor.

18. The system of claim 17, further comprising:
a content analyzer, implemented by at least one of the plurality of processors, configured for analyzing metadata of the media item to determine attributes of the media item, wherein said attributes of the media item correspond to content of the media item.

19. The system of claim 18, wherein the anchor generator is further configured to generate said anchor based upon the quantitative measurements computed by the user behavior analyzer and the metadata of the media item analyzed by the content analyzer.

20. The system of claim 19, wherein the anchor module is configured to communicate said annotated media item to the user for rendering over a network.
